(19) United States
(12) Patent Application Publication
(10) Pub. No.: US 2013/0246995 A1
(43) Pub. Date: Sep. 19, 2013

(54) SYSTEMS, METHODS, AND APPARATUS FOR MODEL-BASED SECURITY CONTROL

(71) Applicants: Lúcio Emanuel Represas Ferrão, Lisboa (PT); João Ricardo Viegas da Costa Seco, Cascais (PT); Luis Manuel Marques da Costa Caires, Lisboa (PT); Gonçalo Filipe Xavier Caleira Borrêga, Alcabideche (PT); António Augusto Vieira Melo, Lisboa (PT)

(72) Inventors: Lúcio Emanuel Represas Ferrão, Lisboa (PT); João Ricardo Viegas da Costa Seco, Cascais (PT); Luis Manuel Marques da Costa Caires, Lisboa (PT); Gonçalo Filipe Xavier Caleira Borrêga, Alcabideche (PT); António Augusto Vieira Melo, Lisboa (PT)

(73) Assignee: OutSystems - Software em Rede S.A., Linda-A-Velha (PT)

(21) Appl. No.: 13/418,922

(22) Filed: Mar. 13, 2012

(51) Int. Cl. G06F 9/44; G06F 9/45

(52) U.S. Cl. 717/104

(57) ABSTRACT

An integrated model-driven application development and execution environment enables declaration of a data-role in an application model. The data-role is based on a property of a data entity in the application model. The data-role provides for the enforcement of domain-specific security policies with respect to data elements corresponding to the data entity.

### FIELD OF THE INVENTION

In various embodiments, the present invention relates to model-driven software applications and, in particular, to systems and methods for developing and/or executing such applications.

### BACKGROUND

Security of data and control of access thereto are important concerns for many software systems/applications, e.g., web-based information systems, accounting systems, client-management systems, etc. Such software systems typically support several types of users who are subject to different profiles with respect to the application data. For example, in a typical business application, the nature of access to the application data (e.g., records, reports, etc.) to be granted to employees, customers, and vendors of the business can be significantly different. Therefore, these user types are often subject to fine-grained data and access control policies, which are usually defined within both the business application data model and the application logic.

In many software applications, the security policies are not merely based on the type of user (e.g., employee, customer, vendor, etc.), but are also or instead based on the characteristics of the functionality provided by the software application. For example, in a “Social Network” application, not all subscribers of the network can see pictures of all other subscribers; only the subscribers who are designated as “Friends” of a certain subscriber can see pictures of that subscriber. As another example, in a “Recruitment” application, the submitted job applications can only be accessed by screeners (i.e., recruiters) certified for a particular area of professional expertise. Moreover, if a screener has engaged in an evaluation of a particular candidate, it may be desired that any supplemental information submitted by that candidate is accessible only to the screener who is evaluating that candidate. In other words, it may be desired that other screeners, though certified for the area of professional expertise of the candidate, not be able to access the candidate's supplemental information.

In general, security policies that are domain specific, i.e., specific to the particular business-application model, data, and logic, have not been modeled in traditional role-based-access-control models. In the context of model-driven application development, a developer intuitively and straightforwardly specifies elements of an application model—each element describing the intended or desired behavior of a component of the application program to be generated from the application model. It is often difficult or impractical for the developer to identify several interactions among those model elements and any unintended behaviors resulting therefrom. As such, it has in the past been very difficult to model a security layer comprising constraints limiting or preventing the unintended behaviors that are themselves difficult to contemplate.

In many traditional systems, keeping a security layer of a software system conformant with various domain-specific security policies therefore requires the developers to construct carefully crafted security layers or to customize generic security middleware, or, frequently, to proliferate security code snippets in the application. This adds complexity to application-code development and maintenance, promotes error-prone coding, and may cause security breaches.

Some modern software applications, e.g., web-based applications, present another challenge to the maintenance of security. These applications regularly evolve (e.g., they are updated to provide new features, to support new hardware platforms, etc.) in order to comply with new requirements from users and to provide competitive services. When the developers change the functionality of the application, they need to keep the underlying security layer consistent with the new changes, requiring security code auditing and re-coding.

To mitigate some of these issues, generic access control middleware, application programming interfaces (APIs), and low-level support mechanisms have been provided, usually based on declarative role-based access control, which can facilitate integrated management of application security in a limited manner. These solutions include exposing application resources and data to a security management subsystem, but do not free developers from the burden of producing, validating, and maintaining customized security code elements, such as wrappers, plug-ins, triggers, and/or views.

Furthermore, the role-based-access-control mechanisms tend to be inflexible and difficult to manage, requiring the developer to map required business-level security policies into low-level configuration mechanisms that are difficult to audit and validate. These mechanisms also generally fail to offer a globally consistent high-level view of application security, expressed in terms of the specific business model and synchronized across all tiers of the generated application, and do not offer an integrated support for configuration and auditing by the security architect. In addition, the role-based mechanisms typically cannot enforce security policies at compile time, or signal their violation in a similar fashion to other kinds of programming errors.

Accordingly, there is a need for improved systems, methods, and apparatus that facilitate the declaration of models that can capture security policies of the underlying software application.

### SUMMARY OF THE INVENTION

In various embodiments of the present invention, an integrated model-driven programming and execution environment for developing and/or executing data-centric software applications facilitates maintenance, validation, and automatic generation of security enforcement code layers for the data-centric applications. This is achieved, in part, by allowing a developer to declare relationships between model entities and/or security rules that depend not only on a business role of a user but also on one or more properties of one or more model elements that the user may access or process according the user's business role.

In particular, a developer may provide data based declarations, called data-roles, of business roles and entity-based declarations of custom business capabilities, which can provide for broad and reflexive model-based control of application security. An exemplary data-role is “ProposalOwner,” a member thereof being an application user with the business role of a proposal owner, but only in relation to some of the proposals that are instances of a data entity “Proposal,” the instances being included in the application data. An exemplary security policy may require that application users can only access the proposals they own by associating the data-role ProposalOwner with a built-in read capability of the Proposal data entity. By extension, an exemplary custom business-level capability “Approve” of the entity “Proposal” may be used to limit application users to performing an “approve” operation only on the proposals he or she owns.

A security layer can be generated based on the declarations of data-roles and security rules associating data-roles and conditions with capabilities of application model elements, thereby allowing the application security to be easily and flexibly customized and enforced, both at development time and at runtime, according to the specific business model and logic of each application. The security layer can be integrated with the application model and the corresponding software application, e.g., at the model or design level, compiled code level, and at runtime, thereby providing robust security and protection of data at various stages of application development and during the execution of the software application.

In general, in one aspect, embodiments of the invention feature a computer-implemented method for enabling model based security control. The method includes storing, in computer memory, an application model modeling an architecture for an executable application program. The application model includes data entities. The method also includes incorporating a data-role model within the application model. The data-role model grants a business role to an application user with respect to a first data entity. The business role is based on a property of the first data entity, and the data-role model models a portion of the architecture for the executable application program.

In general, in another aspect, embodiments of the invention feature a system for enabling model based security control. The system includes a model editor for incorporating a data-role model within an application model. The application model includes data entities and models an architecture for an executable application program. For its part, the data-role model models a portion of the architecture for the executable application program, and grants a business role to an application user with respect to a first data entity. The business role is based on a property of the first data entity. The system also includes a compiler for compiling the application model using a processor, after the data-role model has been incorporated within the application model, so as to generate the executable application program for storage in computer memory. Optionally, although not necessarily, the system may further include an interpreter for executing the application program in the computer memory.

In general, in yet another aspect, embodiments of the invention feature an article of manufacture storing computer-readable instructions thereon for enabling model based security control. The article of manufacture includes instructions for storing, in computer memory, an application model that includes data entities and that models an architecture for an executable application program. The article of manufacture also includes instructions for incorporating a data-role model within the application model. The data-role model grants a business role to an application user with respect to a first data entity. The business role is based on a property of the first data entity, and the data-role model models a portion of the architecture for the executable application program.

Various embodiments of the foregoing methods and systems may include the following features or may implement the following features using, for example, components, modules, and/or hardware (e.g., the model editor, a model validator, the model compiler and/or interpreter, a data repository such as the computer memory, and/or a runtime infrastructure), while various embodiments of the foregoing articles of manufacture may store computer-readable instructions thereon for implementing the following features. A query entity and/or a condition may be associated with the data-role model. The data-role model may also be based on a second data entity. In addition, the data-role model may include a parameter upon which the business role is based. A custom capability may also be associated with a model element in the application model.

In one embodiment, a security rule that associates both the data-role model and a condition with a capability of a model element in the application model is provided. The data-role model may include a parameter upon which the business role is based. The data-role model used in the security rule may also be limited by the parameter, which may be parameterized from the context of the capability of the model element. In another embodiment, a security rule that associates a first capability of a first model element with a second capability of a second model element in the application model is provided. The security rule may be enforced at at least one tier of a plurality of tiers corresponding to the application model.

In addition, a security layer that includes security rules may be incorporated within the application model. The security layer may be integrated with an executable application program generated from the application model, and the security rules in the security layer may be enforced when the executable application program is executed.

In another embodiment, the application model is annotated with a security layer that includes one or more security rules. The annotation may be performed if at least one element of the application model has changed. The annotation may include identifying a violation of a security rule, and/or reporting the identified security rule violation to a developer. Identifying the violation of a security rule on a first model element may include identifying unauthorized access of the first model element.

In yet another embodiment, accessible components of the application model may be identified. The components may be identified via static auditing. In such a case, the accessible components may include an artifact of the application model, and the artifact may be accessible to the data-role model. Alternatively, or in addition, the components may be identified via dynamic auditing. In this latter case, the accessible components may include an artifact of the application model that is accessible at runtime to an application user.

In still another embodiment, a security view of the application model may be generated. This may include identifying one or more operations performable by an application user corresponding to the data-role model, and/or identifying roles that are allowed to perform an operation corresponding to a model element. An expansion of the operation, which may be related to a capability of a second model element, may also be identified.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 schematically depicts an integrated model-driven programming and execution environment, according to an embodiment of the invention;

FIG. 2A schematically depicts a software-application model that includes various model entities, according to an embodiment of the invention;

FIG. 2B schematically depicts the software-application model of FIG. 2A and databases of instances corresponding to various model entities contained within the software-application model, according to an embodiment of the invention;

FIG. 2C schematically depicts the software-application model of FIG. 2A as well as additional model entities contained therein, according to an embodiment of the invention;

FIGS. 3A-3C schematically depict various views of the software-application model depicted in FIGS. 2A and 2C, according to an embodiment of the invention; and

FIG. 4 schematically depicts various stages of developing a software-application model, according to an embodiment of the invention.

### DETAILED DESCRIPTION

Generally, a data-centric application is a software application that includes one or more database components for storing application data and meta-data, one or more application-logic components for implementing a set of functionalities to be applied to the stored data, and one or more presentation components for providing an interface to the end-users or other software applications. The interface can be used to receive data from the end user and/or other applications and to provide the results of applying various functionalities to the stored and/or received data. Examples of data-centric applications include customer-relationship management (CRM) applications, web portals, enterprise-resource planning (ERP) applications, collaborative work applications, social networking applications, etc.

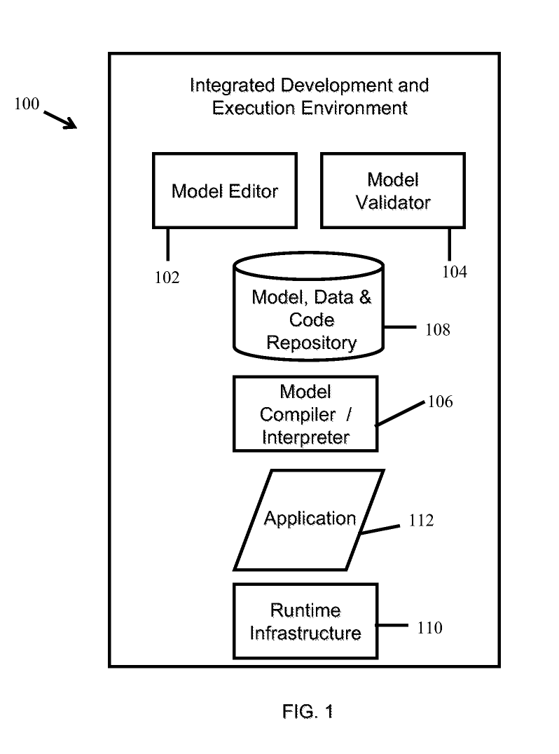

With reference to FIG. 1, an integrated model-driven programming and execution environment 100 is typically a computer system having and/or implementing hardware and/or software and that includes several components such as a model editor 102, a model validator 104, a model compiler and/or interpreter 106, a data repository 108, and a runtime infrastructure 110. The integrated model-driven programming and execution environment 100 can enable creation/development of an application model, and generation and execution of a data-centric application (i.e., a software program/system), such as an application 112, based on the specified application model. In general, an application-model includes descriptions of one or more components of a data-centric software application, describing, for example, their structure, properties, relationships, and modes of presentation, including visual and user interfaces. Other kinds of features (e.g., web blocks, procedures, processes, logic flow, modules, and various user interface elements such as buttons, forms, fields, etc.) may also be described in an application model.

In the integrated model-driven programming and execution environment 100, the model editor 102 provides a set of functionalities for creating, storing, retrieving, editing and updating various application models such as data-entity models, screen-entity models, etc. The model validator 104 provides a set of functionalities for validating the consistency of application models described using the model editor 102.

The model compiler/interpreter 106 provides a set of functionalities for generating an executable software application, e.g., the application 112, based on a specified application model by translating a validated application model into an executable representation thereof. Software applications generated by the model compiler/interpreter 106 may be executed by themselves, or with runtime support from the runtime infrastructure 110 and the data repository 108. A validated application model, or some components thereof, may also be interpreted by the model compiler/interpreter 106.

For its part, the runtime infrastructure 110 provides a set of functionalities for supporting the execution or interpretation of representations of a specified application. The runtime infrastructure 110 can also provide a runtime application-program interface (API) that may be used by several applications running (i.e., executing) simultaneously. The runtime infrastructure 110 also provides support for user authentication and reliable identification of the current user for security verifications.

The data-repository 108 is typically a database component or set of database components where application models and application data and meta data are stored for use by the various components of the integrated model-driven programming and execution environment 100 and by the data-centric applications developed by the environment 100. In particular, a specified application model including various model entities, a validated application model, and other representations of the model such as a partially compiled model, or a fully compiled, executable software application, may be stored in the data repository 108. Moreover, data elements corresponding to various data entities (e.g., employees, customers, vendors, products, goods, purchased items, reports, shipping records, etc.) that may be used during development of the application model and/or execution of the software application 112 based on the application model may be stored in the data repository 108.

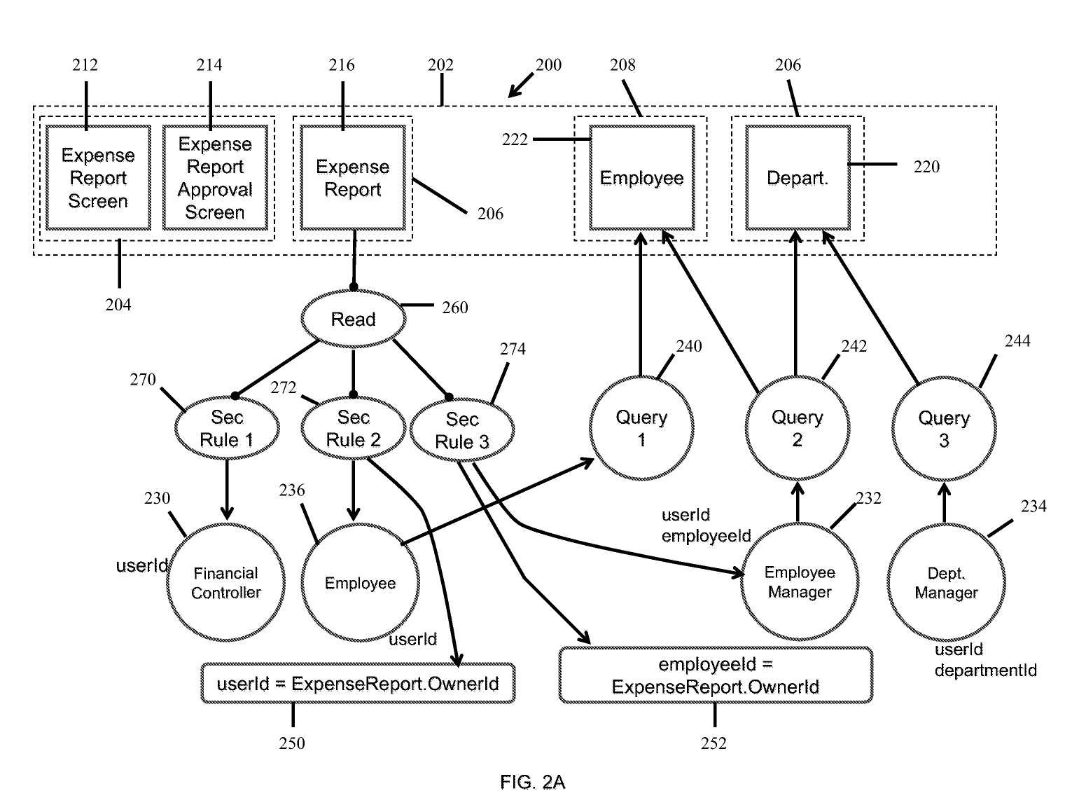

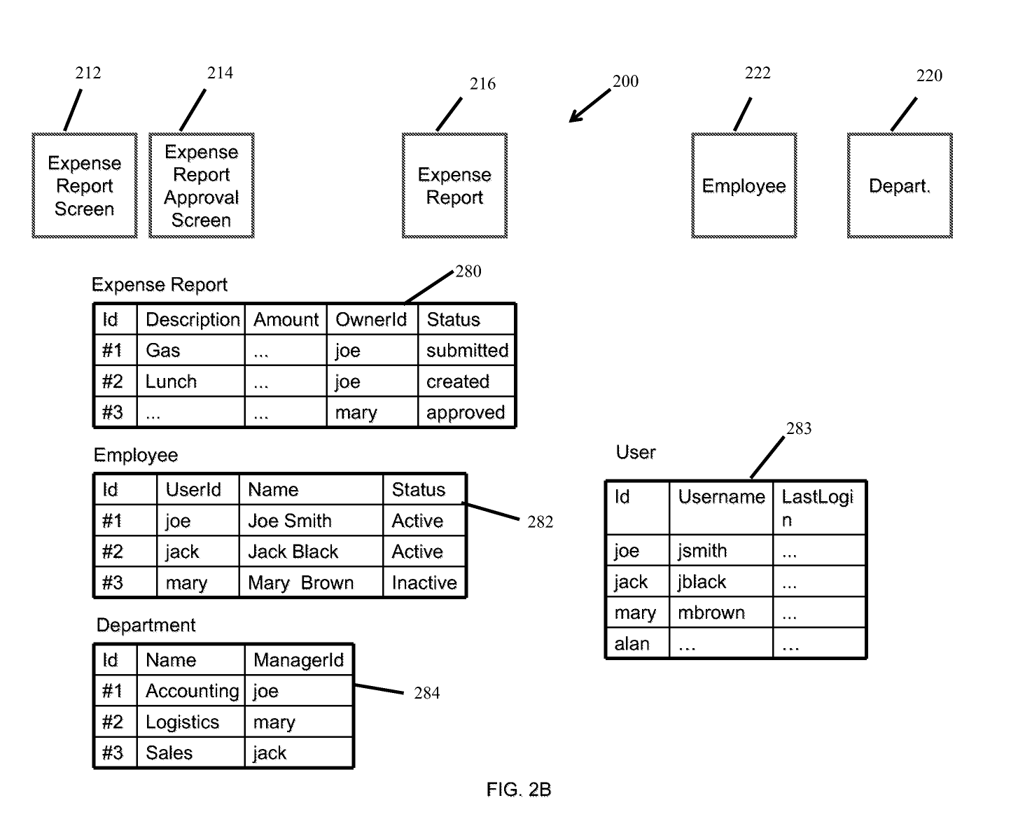

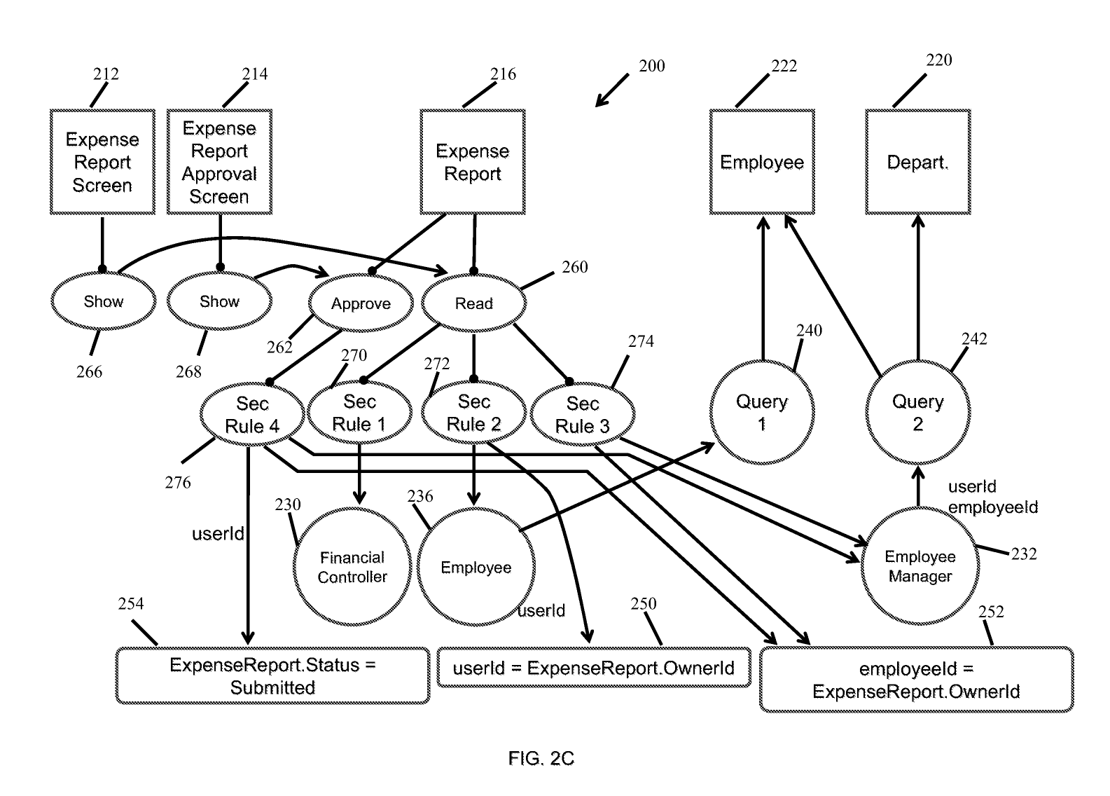

Referring to FIG. 2A, an exemplary software application model 200 includes various application model elements 202, such as screen entities 204 and data entities 206 and 208. The screen entities 204 include an ExpenseReportScreen entity 212 and an ExpenseReportApprovalScreen entity 214. The data entities 206 and 208 include an ExpenseReport entity 216, a Department entity 220, and an Employee entity 222. The application model 200 also includes a simple-role model FinancialController 230, and data-role models Employee 236, EmployeeManager 232, DepartmentManager 234.

One of ordinary skill in the art will understand that in the context of model-based application development, a data entity is merely a model of a data element, and an instance of that model is the actual data element that may be used by a software application generated from the application model 200. For example, data entity Department 220 is a model of the actual data elements corresponding to one or more enterprise departments represented in the application model (e.g., “Sales,” “Engineering,” “Accounting,” etc). Such instances, i.e., data elements, can be created while developing the application model 200 and/or running a software application generated from the application model 200.

Each instance corresponding to a data entity can be uniquely identified by the value of an attribute of the data entity. Each attribute represents a property of the instance. Instances of the data entity Employee 222, i.e., employees, may be uniquely identified, for example, by the attributes “employeeId,” “employeeName,” etc. Similarly, instances of the data entity Department 220, i.e., departments, may be uniquely identified by the attributes “departmentId,” “departmentName,” etc. For clarity and conciseness, we refer to the instances of a data entity by the data-entity's name only, i.e., the instances of data entities such as Employee 222 are merely called employees, and the instances of data entities such as ExpenseReport 216 and Department 220 are merely called expense reports and departments, respectively.

The instances of a data entity typically have other properties as well. With reference to FIG. 2B, for example, a database of expense reports 280 shows three instances thereof, and the expense reports have properties such as “Id,” “Description,” “Amount,” “OwnerId,” and “Status.” A database of employees 282 lists a number of employees, each one having the properties “Id,” “UserId,” “Name,” and “Status,” where “UserId” refers to the user identifier in the runtime infrastructure 110 (also shown is a database 283 that lists information, maintained by the runtime infrastructure 110, on various users). A database of departments 284 lists various departments having the properties “Id,” “Name,” and “ManagerId.”

The databases 280, 282, 284 may be stored in the data repository 108 of FIG. 1. It should be understood that the three instances in each database 280, 282, 284 are illustrative only and that databases having fewer or more instances are within the scope of the invention. It should also be noted that for the sake of clarity, some entities, conditions, capabilities, and/or security rules shown in FIG. 2A are omitted in FIG. 2B, even though the omitted items remain incorporated within the application model 200.

One or more users may be designated a business role. For example, the users may be designated the business role “FinancialController” by declaring the simple-role FinancialController 230 as “FinancialController(userId).” That declaration assigns the business role FinancialController to the user identified by “userId” by the runtime infrastructure 110.

This business role is not limited, i.e., a functionality that is associated with the business role FinancialController can be performed by any user who is designated that business role.

A business role such as “Employee” can be designated to users by declaring the data-role Employee 236 as “Employee(userId).” As in the case of the simple-role FinancialController 230, the data-role “Employee(userId)” designates the business role to any user identified by “userId.” But, as explained below, that designation is limited to the users that are identified by Query 1 240 using the data entity Employee 222.

A business role such as “EmployeeManager” can be designated to users by declaring the data-role EmployeeManager 232 as “EmployeeManager(userId, employeeId).” As in the case of the simple-role FinancialController 230, the data-role EmployeeManager 232 designates the business role “EmployeeManager” to any user identified by “userId.” But, as explained below, that designation is limited by the declaration's second parameter “employeeId” by Query 2 242 using the data entities Employee 222 and Department 220. In other words, unlike the simple-role FinancialController 230, the functionality associated with the business role “EmployeeManager” can be performed by the user identified by “userId,” who is designated that business role, but only with respect to employees identified by “employeeId,” i.e., the employees that are managed by that user.

A business role such as “DepartmentManager” can be designated to users by declaring the data-role DepartmentManager 234 as “DepartmentManager(userId, departmentId).” As explained below, this designation is limited by the declaration's second parameter “departmentId” by Query 3 244 using the data entity Department 220. The functionality associated with the business role “DepartmentManager” can be performed by the user identified by “userId,” who is designated that business role, but only with respect to departments identified by “departmentId.”

For the declared simple-roles and data-roles, the runtime infrastructure 110 (of FIG. 1) can expose an API that allows a security checking function associated with the API to be used by the application model. For example, for the data-role model DepartmentManager 234, the runtime infrastructure 110 can create an API such as “Boolean CheckRole_DepartmentManager(userId, departmentId)” that returns “true” if a user identified by “useId” is the manager of the department identified by “departmentId” and that otherwise returns “false.”

During the performance of tasks associated with a business role granted by a data-role model specified (i.e., declared) in an application model, the instances (i.e., the actual data elements) of the data entities associated with the data-role model must be obtained. To this end, the databases (e.g., the databases 280, 282, 284 of FIG. 2B) corresponding to the data entities may be queried. A query typically returns (i.e., supplies) instances of those data entities upon which the task associated with the data-role is performed. To illustrate, and with reference again to FIG. 2A, a Query 1 240 may be specified as “get all employees E such that for each employee in E, employee.userId=userId.” Using the Query 1 240, an employee having an attribute specified by “userId” can be obtained from the database 282, i.e., the database corresponding to the data entity Employee 222. Some other examples of the Query 1 240 include “get all active employees,” or “get all employees not on vacation.” The Query 1 240 is used by the data-role model Employee 236.

In one embodiment, the data-role model EmployeeManager 232 uses Query 2 242 to access instances of both the data entity Department 220 and the data entity Employee 222. The Query 2 242 obtains an employee identified by “employeeId” and obtains the department to which that employee belongs, e.g., by using the value of an attribute Department of the entity Employee 222 as specified by “employee.department.” For that department, the Query 2 242 further determines if the manager of the department (specified, e.g., in the entity Department 220 by the attribute “department.managerId”) is the user identified by “userId.” If this requirement is met, the user identified by “userId” is the manager of the employee identified by “employeeId” as required by the data-role model EmployeeManager 232.

Alternatively, the Query 2 242 may be specified as “get all employees E such that for each employee in E, employee.id=employeeId AND employee.managerId=userId.” In this alternative form, the Query 2 242 accesses instances of only the data entity Employee 222. Thus, an employee having an id specified by “employeeId” can be obtained from a database corresponding to the data entity Employee 222, i.e., the database 282 of FIG. 2B. If the attribute “managerId,” indicating the employee's manager, has a value that is the same as that of the parameter “userId,” the user identified by “userId” is, in fact, the manager of the employee identified by “employeeId.” If the value of “managerId” indicates that the manager of the employee is not the user identified by “userId,” the Query 2 242 may return a NULL value, i.e., the Query 2 242 may not supply any instance of an employee from the database corresponding to the data entity Employee 222.

As another example, a Query 3 244, declared as “get all departments D such that for each department in D, department.managerId=userId” can be used by the data-role model DepartmentManager 234 to obtain all departments for which the designated manager is the user identified by “userId.” Some queries do not limit the instances obtained from the database, as illustrated above. For example, the Query 3 244, declared in the alternative as “get all departments D,” simply returns all instances of departments in the database corresponding to the data entity Department 220. A query can be expressly specified or declared by a developer, or may be inferred from the parameters of a data-role model entity declared by the developer.

Sometimes, the developer may specify a condition to be applied to the instances obtained by querying one or more databases, that is, a task associated with a business role granted by a data-role model is performed on an instance only if the specified condition is met. For example, with reference still to FIG. 2A, a condition 250, declared as “userId=ExpenseReport.OwnerId,” is associated with the data-role model Employee 236. Recall that the Query 1 240 may supply an employee identified by “userId.” That employee, however, may perform a task allowed by the data-role model Employee 236 only with respect to those expense reports that meet the condition 250. Specifically, the owner (e.g., creator) of the expense report must be the employee identified by the parameter “userId.” Thus, a user (i.e., an employee) cannot perform any task allowed by the data-role model Employee 236 with respect to those expense reports for which the user is not the owner.

In addition to, or as an alternative to, expressly specifying conditions in the application model, the conditions may be inferred from the parameters of a data-role model entity declared by the developer. Moreover, a condition may also be specified while declaring a query. For example, the Query 2 242, as described above, may be viewed as specifying the condition “department.managerId=userId.” In its alternative form, also described above, the Query 2 242 may be viewed as specifying the condition “employee.id=employeeId AND employee.managerId=userId.” These conditions may be associated with the data entity EmployeeManager 232.

An entity in an application model may also have one or more capabilities associated therewith. Typically, a capability of an entity describes an operation that can be performed by a user on one or more instances of that entity. The data entity ExpenseReport 216, for example, has a Read capability 260, i.e., the operation “read” can be performed on expense reports that are instances of the data entity ExpenseReport 216.

In general, in model-driven application development, a security rule associates a role (i.e., a simple-role or a data-role) and, optionally, a condition with a capability of an entity, thereby controlling access to instances of that entity. A security rule determines, for example, whether one or more instances can be viewed or read, modified, and/or deleted, and whether new instances can be added. Thus, the security rules can protect data elements by allowing them to be accessed only by the authorized users. In the application model 200, a Security Rule 1 270 associates the simple-role model FinancialController 230 with the Read capability 260. Thus, if a developer writes code allowing a user to read any expense report, the Security Rule 1 270 verifies that the user is granted the role FinancialController. As there are no conditions associated with the Security Rule 1 270, however, any user designated the role FinancialController can read any expense report.

A Security Rule 2 272 associates the data-role model Employee 236 and the condition 250 with the Read capability 260. The Security Rule 2 272 allows a user identified by “userId” and granted with the data-role Employee 236 to read expense reports only if that user is the owner of the expense report to be read.

A Security Rule 3 274 associates the data-role model EmployeeManager 232 and a condition 252 with the Read capability 260. The Security Rule 3 274 allows a user identified by “userId” and granted with the data-role EmployeeManager 232 to read expense reports only if that user is the manager of the employee identified by “employeeId.” As described above, this requirement is satisfied by the Query 2 242. Furthermore, the condition 252 applied by the Security Rule 3 274 requires that the owner (e.g., creator) of the expense report sought to be read must be the employee identified by “employeeId.” As such, the combination of the business role “EmployeeManager” and the condition 252 applied by the Security Rule 3 274 ensures that only a user who is a manager of an employee identified by “employeeId” can read those expense reports that are created by that employee.

Accordingly, in contrast to users designated the simple-role FinancialController 230, who can read any expense report, users who are managers of some employees but not of a specified employee cannot read expense reports owned/created by that specified employee. In effect, the data-role model EmployeeManager 232 advantageously allows access to the expense reports to be limited to only a subset of managers, i.e., a manager of an employee who owns/created the expense report. This can provide for improved data protection by avoiding unintended and/or erroneous access by unauthorized users, e.g., other managers.

Various data entities 206 in the application model 200 typically include commonly used capabilities such as create, read, update, and delete, and process-entities include commonly used capabilities such as open, execute, show, and trust. These capabilities, generally called primitive capabilities, specify certain basic operations such as creating, reading (as described above), updating, and deleting instances of data entities 206, and executing a process or showing a form to users to receive information. In addition, developers may specify custom capabilities for various entities in the application model 200.

As depicted in FIG. 2C, the data-entity model ExpenseReport 216 includes a custom capability Approve 262 that allows managers to approve expense reports. For the sake of clarity, some entities, conditions, capabilities, and/or security rules shown in FIG. 2A are omitted in FIG. 2C, even though the omitted items remain incorporated within the application model 200. A Security Rule 4 276 associates the data-role model EmployeeManager 232 and a condition 254 with the custom capability Approve 262. According to the condition 254, the Security Rule 4 276 would allow only a manager of an employee who is the owner of an expense report to approve that report if the status of the expense report is “Submitted.” The status Submitted may suggest that the employee has completed editing and has finalized the expense report. Thus, the custom capability Approve 262 and the Security Rule 4 276, in connection with the data-role model EmployeeManager 232, can beneficially prevent accidental approval (by a manager of an employee) of expense reports that have been created but not finalized by that employee.

For various declared primitive and/or custom capabilities of simple and data-roles, the runtime infrastructure 110 (of FIG. 1) can expose an API that allows a security checking function associated with the API to be used by the application model. For example, for the data entity ExpenseReport 216, the runtime infrastructure 110 can expose an API “Boolean Can_Read(userId, reportId)” that returns “true” if a user identified by “userId” is permitted to read the expense report identified by “reportId,” according to the security rules associated with the Read capability 260 of the data entity ExpenseReport 216, and that otherwise returns “false.” Similarly, an API “Boolean Can_Approve(userId, reportId)” exposed by the runtime infrastructure 110 returns “true” if a user identified by “userId” is permitted to approve the expense report identified by “reportId,” according to the security rules associated with the custom capability Approve 262 of the data entity ExpenseReport 216, and otherwise returns “false.”

Application models often include screen entities for displaying forms or web pages to authorized users so that the authorized users can create, view, update, and/or remove data elements. As stated above, the application model 200 includes the ExpenseReportScreen entity 212 and the ExpenseReportApprovalScreen entity 214. Both screen entities 212, 214 are related to the data entity ExpenseReport 216 because they both allow users to perform operations on the instances of the data entity ExpenseReport 216. Specifically, the ExpenseReportScreen entity 212 allows the authorized users to read expense reports, and the ExpenseReportApprovalScreen entity 214 allows the authorized users to approve expense reports. To this end, as illustrated in FIG. 2C, the ExpenseReportScreen entity 212 includes a Show capability 266 that facilitates the display of a screen (e.g., a web page) to the authorized users whereupon one or more expense reports can be displayed for reading by the authorized users. The ExpenseReportApprovalScreen entity 214 also includes a Show capability 268 that facilitates the display of another screen to the authorized users whereupon one or more expense reports can be displayed for approval, and be approved by the authorized users.

In this example, the Show capability 266 can be viewed as a natural consequence of the relationship between the ExpenseReportScreen entity 212 and the data entity ExpenseReport 216 because for an expense report to be read, it must be shown to a user. As such, the Show capability 266 may be called an expansion or extension of the Read capability 260. Similarly, the Show capability 268 of the screen entity ExpenseReportApprovalScreen 214 may be called an expansion of the Approve capability 262. In the application model 200, various expansion capabilities can be specified by a developer using the model editor 102 (shown in FIG. 1).

As an application model is being developed, the developer may annotate the model with specified security rules and, optionally, logical implications of those rules. In the application model 200 for example, the Security Rule 2 272 ensures, according to the condition 250, that only the employee who is the owner of an expense report is able to read that expense report. As described above, the Security Rule 3 274 enforces the condition 252, which is similar to the condition 250. However, if a developer declares the Security Rule 3 274 without requiring condition 252, there will be a security violation because a manager will be able to read a report that is not created by the employee identified by “employeeId.”

As another example, with reference again to FIG. 2A, if a developer writes an application model for retrieving data of an expense report by a user that does not fulfill any of the security rules 270, 272 and 274, there would be a violation of those security rules. This violation can be detected by the model validator 104 at development or compile time by analyzing static information of the application model, or omission thereof. If the developer also wishes to provide access to the expense reports to other kinds of users, e.g. DepartmentManager 234, a new security rule must be created associating the Read capability 260 of the ExpenseReport 216 data entity with the data-role DepartmentManager 234.

In the above examples, there was unauthorized access to instances of the data entity ExpenseReport 216, e.g., by employees that are not the owners/creators of the expense report being accessed, or by users not granted with the data-role EmployeeManager 232. As other examples, a developer may change the application model 200 by adding a new query that violates one or more security rules, or the developer may update the Read capability 260 by declaring the Security Rule 3 274 without requiring the condition 252. The annotation of the application model 200 and/or the check of the security rules for their violations by the model validator 104 may be invoked when the application model 200 and/or other models included therein (e.g., the Read capability 260) are changed and/or updated by the developer. The detection of a violation of one or more security rules by the model validator 104 during such a check can prevent the unauthorized accesses described above, thereby protecting the data elements.

As an application model is being developed, the model validator 104 and/or the compiler/interpreter 106 (shown in FIG. 1) may also create a security layer. The security layer, which includes specified and inferred security rules as described above and, optionally, the logical implications of those rules, may be integrated with various tiers of the application model.

In static verification of a security rule, the model compiler/interpreter 106 detects whether the attributes of the data entities associated with the data-role definitions and security rule definitions are protected. For example, with respect to Security Rule 2 272 and the data-role model Employee 236, the model validator 104 may determine that changes to the attribute OwnerId of the data entity ExpenseReport 216 referred to in condition 250 needs to be protected.

In dynamic verification, the model compiler/interpreter 106 creates a security layer at the compiled-code level by inserting security rules into all generated artifacts, i.e., the instances of actual data elements corresponding to various data entities. In particular, the model compiler/interpreter 106 can insert filters on data selection in connection with the query operations, and guards on operations of other programming elements (e.g., capabilities of data-entity models). For example, the security rules protecting expense reports may be integrated with a query accessing the expense reports by adding conditions to filter the data retrieved from the data entities involved, or by invoking the required security-rule checking functions via the APIs described above. Using filters, only the rows of the database that satisfy the security rule based on a parameter thereof (e.g., a parameter “userId” that identifies the current user of the data element being accessed) may be retrieved. Using guards, the runtime infrastructure 110 may cause a security exception to be thrown at runtime, signaling a security violation. Thus, using an annotated application model (e.g., the annotated application model 200) created as described above, model consistency in terms of access to various model entities and/or instances thereof can be continuously verified in the integrated model-driven programming and execution environment 100.

Moreover, as described above, the environment 100 can explore the declarations of data-roles and security rules. Based, in part, on the parameters of model entities specified in these declarations, the environment 100 can automatically generate model-specific API security functions that encapsulate the desired security checks. Examples of such security functions include the “CheckRole_DepartmentManager,” “Can_Read,” etc. security functions described above. The automatically generated security functions may be used anywhere in the application model.

The model editor 102 can also audit an application model so as to provide different perspectives of the model (called “views”) to the model developer. These views can assist the model developer in determining whether the desired features of the software application are represented in the application model, and whether any unintended features have been introduced erroneously. A view may show the components that are accessible to a specific data-role, and the conditions necessary to access them. To illustrate, consider the data-role Employee 236. The components accessible thereto include the data entity ExpenseReport 216 under the Read capability 260 and the condition 250, and the ExpenseReportScreen 212 under the Show capability 266 and the same condition 250. These accessible components (e.g., various entities in the application model 200) can be determined statically, i.e., without executing the application program generated from the application model 200. During runtime, the specific expense reports accessible to a certain employee, e.g., Joe, can be identified, based on the data-roles granted to user Joe and whether Joe is the creator of any of these expense reports and/or a manager of one or more employees who created those expense reports. A view may also show what data-roles may be granted to a user and which conditions must be satisfied in order for a user to be allowed to perform an operation on a application model element.

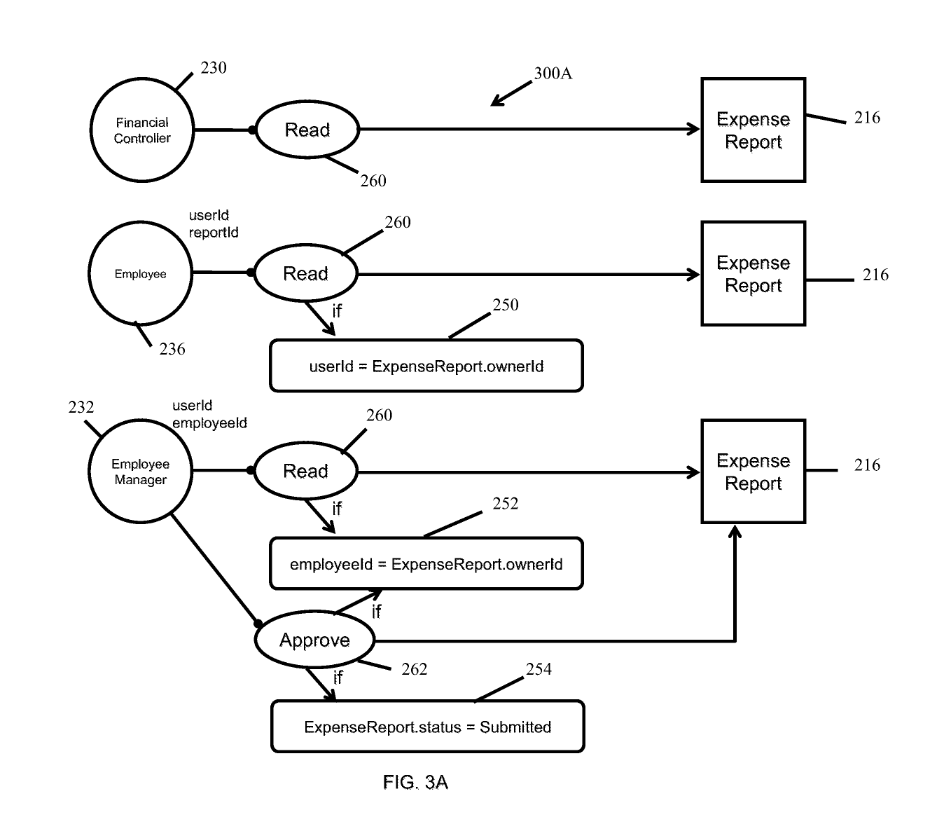

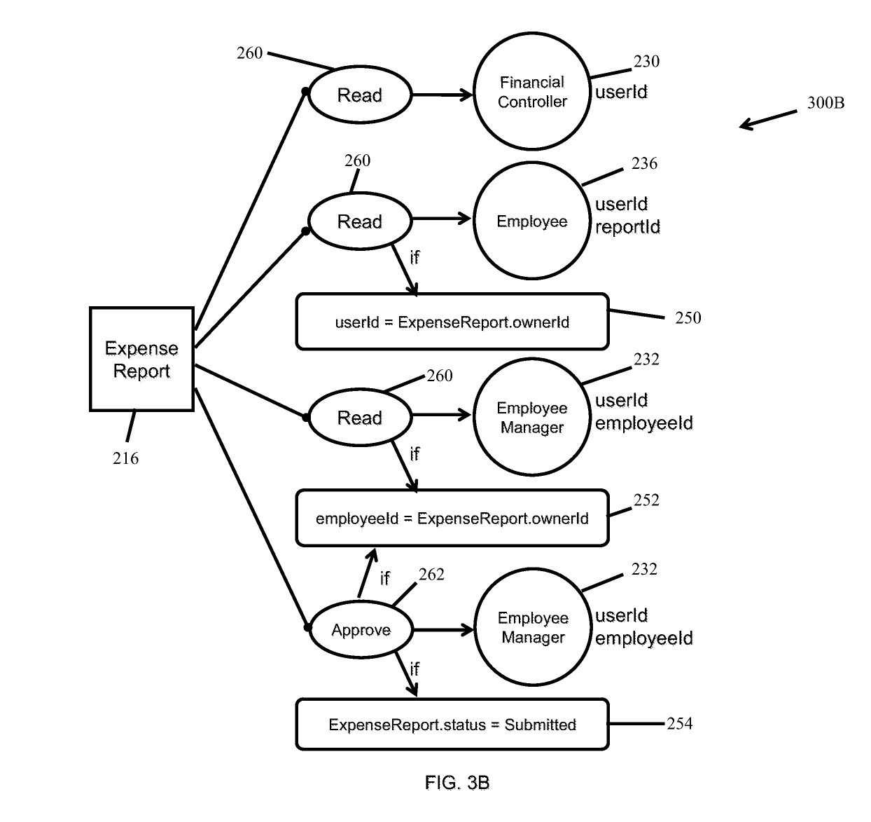

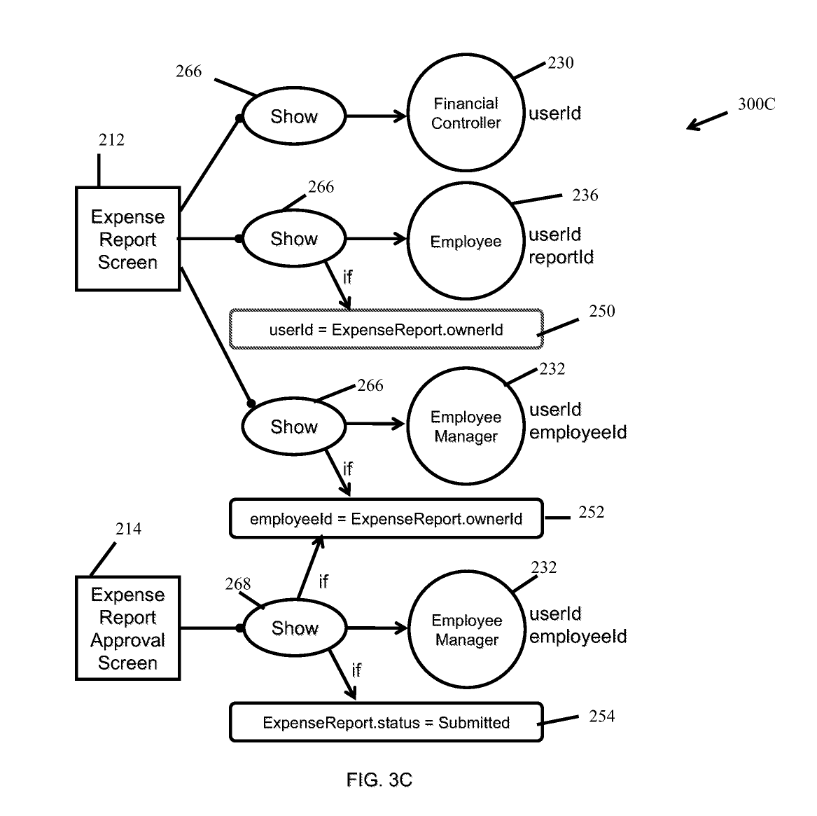

A view 300A, illustrated in FIG. 3A, is a user-centric view, i.e., the view 300A depicts what operations a user having a particular business role can perform on a given programming element, e.g., an entity in the application model. For instance, a user having the business role “FinancialController,” as specified by the simple-role model FinancialController 230, can perform the Read operation 260 on the data entity ExpenseReport 216 (and, although not illustrated, a Show operation 266 on the application model element ExpenseReportScreen 212). A user having the data-role Employee 236 can also perform the Read operation 260 on the data entity ExpenseReport 216 (and, although not illustrated, the Show operation 266 on the application model element ExpenseReportScreen 212), but only if the condition 250 is satisfied, i.e., the user is the owner/creator of the expense report being read.

View 300A also shows that a user granted with the data-role model EmployeeManager 232 can perform the Read operation 260 on the data entity ExpenseReport 216 if the condition 252 is satisfied, which requires that the owner/creator of the expense report be the employee identified by “employeeId.” According to the data-role model EmployeeManager 232, a user can also perform the Approve operation 262 on the data entity ExpenseReport 216 if the condition 252 and the condition 254 are satisfied As described above with reference to FIGS. 2A and 2C, in addition to the conditions 252, 254, the data-role model EmployeeManager 232, according to the declaration thereof, requires that the user identified by “userId” be the manager of the employee identified by “employeeId.”

A view 300B, illustrated in FIG. 3B, is an operation-centric view that identifies various roles that can perform a specified operation on a programming element, such as a data entity and/or a screen application model element. For example, on the data entity ExpenseReport 216, read operations provided by the Read capability 260 can be performed by the simple-role model FinancialController 230, and by the data-role models EmployeeManager 232 and Employee 236. Moreover, the approve operation provided by the Approve capability 262 can be performed on the data entity ExpenseReport 216 by the data-role model EmployeeManager 232. Thus, the view 300B can be used by a developer to verify that only the business role “EmployeeManager” and no other business roles designated by other simple or data-role models can invoke the Approve capability 262.

With reference to FIG. 3C, a view 300C depicts expansion of capabilities, i.e., the operations and entities corresponding to the expanded capabilities, and the roles that can invoke the expanded capabilities. The Read capability 260 (shown in FIG. 3B), for example, can be expanded in to the Show capability 266 with respect to a screen entity ExpenseReportScreen 212. As described above, this expansion indicates that an expense report screen may be shown to users that may perform the read operation on expense reports. As such, the Show capability 266 of the screen entity ExpenseReportScreen 212 can be provided to the simple-role model FinancialController 230, and to the data-role models EmployeeManager 232 and Employee 236. The Show capability 268 of the screen entity ExpenseReportApprovalScreen 214 can be provided to the data-role model EmployeeManager 232.

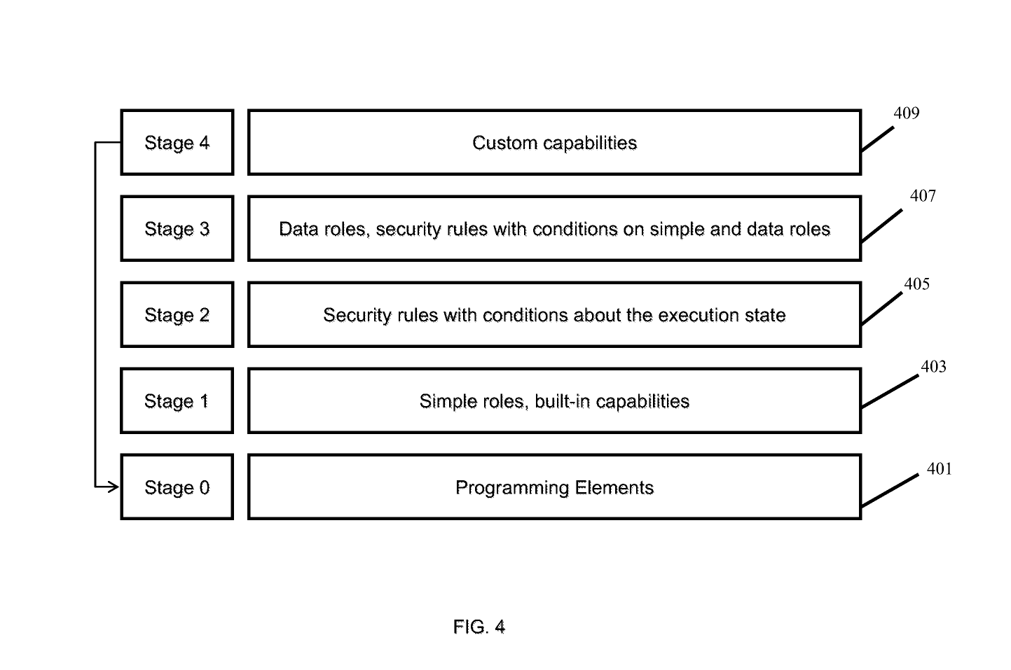

In the integrated model-driven programming and execution environment 100, the model editor 102 can be used to declare various model entities in an incremental manner, starting with the declaration of the entities requiring a short specification, and enhancing the application model by subsequently declaring other entities that provide a richer set of attributes and/or functionalities. With reference to FIG. 4, in one exemplary cycle of application-model development, at stage 0 401 basic application functionality is declared without special security concerns based on data-model entities, basic logic, and certain presentation elements. At stage 1 403, simple security requirements are added by declaring simple-roles and model annotations (e.g., basic capabilities). At stage 2 405, conditions may be added to security rules declared in stage 1 403.

Various data-role models, expressing strong domain-specific constraints that may be based on the specific application-data model, can be added in stage 3 407. At stage 4 409, custom capabilities may be introduced, helping the security architect to express the intended security checks in terms of business level operation protection. It should be understood that the cycle depicted herein can be repeated, starting from declaration of other relatively simple entity models to be included in the application model at stage 0 401, and enhancing of those models in the stages 1 403 through 4 409. During these stages the security architect can navigate the security layer using the various security views, as described above, to analyze what roles and users may actually access what data and elements under what conditions in the data-centric application generated from the application model.

As will be understood by one of ordinary skill in the art, various components of the integrated model-driven programming and execution environment 100 (i.e., the model editor 102, the model validator 104, the compiler/interpreter 106, the data repository 108, etc.) can be implemented in hardware (e.g., as integrated circuits, FPGAs, etc.), software, or combination thereof. In general, the components implemented as software may be coded and implemented in any programming language, including, for example, C, C++, or JAVA. The software components may be further translated into machine language or virtual machine instructions and stored in a program file in that form. The program file may then be stored on or in one or more computer-readable articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape.

If one or more of the components of the integrated model-driven programming and execution environment 100 (e.g., the model editor 102, the model validator 104, the compiler/interpreter 106, the data repository 108, etc.) are implemented, at least in part, in software, those software portions may be executed using any type of personal computer, Windows-based terminal, network computer, wireless device, information appliance, RISC Power PC, X-device, workstation, mini computer, main frame computer, personal digital assistant, set top box, handheld device, or other computing device that is capable of both presenting information/data to, and receiving commands from, a user of the environment 100. In general, a computer system implementing the integrated model-driven programming and execution environment 100 in hardware, software, or a combination thereof may include, for example, a visual display device (e.g., a computer monitor), a data entry device (e.g., a keyboard, a mouse, etc.), persistent and/or volatile storage (e.g., computer memory), and a processor.

The invention can be embodied in other specific forms without departing from the spirit or essential characteristics thereof. The foregoing embodiments are therefore to be considered in all respects illustrative rather than limiting on the invention described herein.

What is claimed is:

1. A computer-implemented method for enabling model based security control, the method comprising:
storing, in computer memory, an application model modeling an architecture for an executable application program, the application model comprising data entities;
incorporating a data-role model within the application model, the data-role model granting a business role to an application user with respect to a first data entity, the business role being based on a property of the first data entity, and the data-role model modeling a portion of the architecture for the executable application program.

2. The method of claim 1, wherein the data-role model is further based on a second data entity.

3. The method of claim 1, further comprising associating a query entity with the data-role model.

4. The method of claim 1, further comprising associating a condition with the data-role model.

5. The method of claim 1, further comprising associating a custom capability with a model element in the application model.

6. The method of claim 1, further comprising providing a security rule associating both the data-role model and a condition with a capability of a model element in the application model.

7. The method of claim 6, wherein the data-role model comprises a parameter upon which the business role is based, the data-role model used in the security rule is limited by the parameter, and the parameter is parameterized from the context of the capability of the model element.

8. The method of claim 1, further comprising providing a security rule associating a first capability of a first model element with a second capability of a second model element in the application model.

9. The method of claim 8, further comprising enforcing the security rule at at least one tier of a plurality of tiers corresponding to the application model.

10. The method of claim 1, wherein the data-role model comprises a parameter upon which the business role is based.

11. The method of claim 1, further comprising incorporating, within the application model, a security layer comprising security rules.

12. The method of claim 11, further comprising integrating the security layer with the executable application program generated from the application model.

13. The method of claim 12, further comprising enforcing the security rules in the security layer when the executable application program is executed.

14. The method of claim 1, further comprising annotating the application model with a security layer, the security layer comprising one or more security rules.

15. The method of claim 14, wherein the annotating comprises identifying a violation of any security rule.

16. The method of claim 15, wherein the annotating further comprises reporting the identified security rule violation to a developer.

17. The method of claim 15, wherein identifying the violation of a security rule on a first model element comprises identifying unauthorized access of the first model element.

18. The method of claim 14, wherein the annotating is performed if at least one element of the application model is changed.

19. The method of claim 1, further comprising identifying accessible components of the application model.

20. The method of claim 19, wherein the identifying is performed via static auditing, and the accessible components comprise an artifact of the application model, the artifact being accessible to the data-role model.

21. The method of claim 19, wherein the identifying is performed via dynamic auditing, and the accessible components comprise an artifact of the application model accessible at runtime to an application user.

22. The method of claim 1, further comprising generating a security view of the application model.

23. The method of claim 22, wherein generating the security view comprises identifying one or more operations performable by an application user corresponding to the data-role model.

24. The method of claim 22, wherein generating the security view comprises identifying roles that are allowed to perform an operation corresponding to a model element.

25. The method of claim 24, further comprising identifying an expansion of the operation, the expansion being related to a capability of a second model element.

26. A system for enabling model based security control, the system comprising:
a model editor for incorporating a data-role model within an application model, the application model comprising data entities and modeling an architecture for an executable application program, and the data-role model (i) modeling a portion of the architecture for the executable application program and (ii) granting a business role to an application user with respect to a first data entity, the business role being based on a property of the first data entity; and
a compiler for compiling the application model using a processor, after the data-role model has been incorporated within the application model, so as to generate the executable application program for storage in computer memory.

27. The system of claim 26 further comprising an interpreter for executing the application program in the computer memory.

28. An article of manufacture storing computer-readable instructions thereon for enabling model based security control, the article of manufacture comprising:
instructions for storing, in computer memory, an application model comprising data entities and modeling an architecture for an executable application program; and
instructions for incorporating a data-role model within the application model, the data-role model granting a business role to an application user with respect to a first data entity, the business role being based on a property of the first data entity, and the data-role model modeling a portion of the architecture for the executable application program.
